(19) United States
(12) Patent Application Publication
(10) Pub. No.: US 2025/0271091 A1
(43) Pub. Date: Aug. 28, 2025

(54) HEATER HOSE WITH MULTI-VOLTAGE FUNCTIONALITY AND CONSTANT POWER OUTPUT

(71) Applicant: Parker-Hannifin Corporation, Cleveland, OH (US)

(72) Inventors: Sahil GUPTA, Aurora, OH (US); Tom LININGER, Mantua, OH (US); Corey PRUCHNIK, Macedonia, OH (US); Isaac J. COLLIER, Sagamore Hills, OH (US)

(73) Assignee: Parker-Hannifin Corporation, Cleveland, OH (US)

(21) Appl. No.: 18/554,640

(22) PCT Filed: Apr. 12, 2022
(86) PCT No.: PCT/US2022/024338

§ 371 Date: Oct. 10, 2023

Related U.S. Application Data
(60) Provisional application No. 63/196,245, filed on Jun. 3, 2021.
(60) Provisional application No. 63/243,971, filed on Sep. 14, 2021.

(51) Int. Cl. F16L 53/37; B29C 48/00; B29C 48/10; B29K 77/00; B29L 23/00; B32B 1/08; B32B 15/02; B32B 15/08; F16L 53/38; H05B 3/58

(52) U.S. Cl. CPC F16L 53/37; B32B 1/08; B32B 15/02; B32B 15/08; F16L 53/38; H05B 3/58; B29C 48/0021; B29C 48/0022; B29C 48/10; B29C 2793/009; B29K 2077/00; B29K 2995/0007; B29L 2023/005; B32B 2307/202; B32B 2307/206; B32B 2307/302; B32B 2307/404; B32B 2597/00; H05B 2203/002; H05B 2203/007; H05B 2203/017

(57) ABSTRACT

A heater hose assembly configuration has multiple electrically conductive layers (12, 14, 16, 18) of heating wires that are separated from each other by electrically non-conductive separating layers (22, 24, 26). The individual heating wires are electrically connectable in series to other individual heating wires, either to individual heating wires within a given electrically conductive layer and/or to individual heating wires of an adjacent electrically conductive layer. The total electrical resistance of the system is determined by the number of series-connected individual heating wires of the electrically conductive layers. Given that user input voltage supplies can differ in voltage level, the output power of the heater hose can be set to a same, desired total output power by series-connecting a selected number of individual heating wires based on the particular input voltage level that is accessible to achieve such desired total output power.

### FIELD OF INVENTION

The present application relates broadly to heater hoses, and more particularly to a heater hose construction having a plurality of heater elements providing multi-voltage functionality and constant power output.

### BACKGROUND

Conventional electrical heater hoses are fabricated by wrapping an electrical conductor around a flexible inner tube, and then enshrouding the wrapped inner tube in a sheathing. In many applications that employ heater hoses, the flexible inner tube includes a nylon core reinforced with a fiber or aramid braid, which is covered with a polyurethane sleeve. The inner tube is then wrapped with conductive wiring, and the conductive wiring typically includes a flat copper wire that can either be a solid ribbon or braided strands. The conductive wiring functions as a resistance heating element, whereby heat is generated by an electric current flowing through the conductive wiring when the conductive wiring is electrically connected to an input voltage supply. A flat wire configuration in particular enables the heater hose to have a smaller diameter, and also increases the area of contact between the flexible inner tube and the conductive wiring that acts as the heating element. The outer sheathing typically is configured as a butyl sleeve.

Conventional heater hose configurations have proven to be limited in application. One issue associated with conventional heater hose configurations is that different end users may employ electrical systems having different input voltage levels. Often, heater hoses are powered by direct current supplies as to which the voltage can vary depending on the end user, with 12V, 24V, and 48V input voltage supplies being typical for common applications. The conventional heater hose configurations tend to be fixed as to the electrical resistance of the heating element due to the permanent and unmodifiable nature of the configuration of the conductive wiring. Accordingly, the attachment of a given heater hose will result in a different power output from the conductive wiring depending upon the input voltage level. This could render a given heater hose unsuitable for a particular application as the power output may be either too high or too low. One option is to manufacture a given heater hose with a configuration to match a given input voltage level to achieve the desired power output, but having to manufacture different heater hoses with different wiring configurations to accommodate different input voltage levels would be costly and cumbersome.

### SUMMARY OF INVENTION

There is a need in the art, therefore, for an improved heater hose configuration that is readily adaptable to different input voltage levels to be able to maintain a desired total power output regardless of the voltage level of the input voltage supply. Such enhancement generally is achieved by a hose assembly configuration that has multiple conductive layers of heating wires that are separated from each other by non-conductive separating layers. Individual heating wires of the conductive layers are electrically connectable in series to other individual heating wires of the conductive layers, either to individual heating wires within a given conductive layer and/or to individual heating wires of an adjacent conductive layer. The total electrical resistance of the system is determined by the number of series-connected individual heating wires of the conductive layers. Given that user input voltage supplies can differ, the output power of the heater hose can be set to a same, desired total output power by series-connecting a selected number of individual heating wires based on the particular input voltage level that is accessible to achieve such desired total output power.

A heater hose, therefore, includes: an electrically non-conductive core tube; a plurality of electrically conductive layers, wherein an electrically conductive layer of the plurality of electrically conductive layers surrounds the electrically non-conductive core tube; an electrically non-conductive separating layer between each two adjacent electrically conductive layers of the plurality of electrically conductive layers, each successive layer of the electrically non-conductive separating layer and plurality of electrically conductive layers surrounding a radially inward layer of the electrically non-conductive separating layer and plurality of electrically conductive layers; and an electrically non-conductive and thermally insulating cover layer surrounding an outermost electrically conductive layer of the plurality of electrically conductive layers. The electrically conductive layers each includes individual heating wires that are electrically connectable in series, whereby a number of series-connected heating wires is selected to set the resistance of the system to provide a same total output power based of the input voltage level.

A method of manufacturing a heater hose includes the steps of: extruding a thermoplastic polymer composition that forms an inner core tube; helically wrapping a first electrically conductive layer on the inner core tube; extruding a polymeric composition on the first electrically conductive layer to form a first separating layer; helically wrapping a second electrically conductive layer on the first separating layer; extruding a polymeric composition on the second electrically conductive layer to form a second separating layer; helically wrapping a third electrically conductive layer on the second separating layer; and extruding a polymeric composition with a foamed cellular structure to form a thermal insulating layer. The method further may include the steps of cutting the hose assembly to a length greater than a desired final length; skiving and removing from both ends of the hose assembly the outer insulating cover layer and underlying electrically conductive and separating layers to the desired final length, thereby exposing first, second, and third pairs of individual heating wires respectively of the first, second, and third electrically conductive layers; unravelling the first pair of individual heating wires of the first conductive layer from both ends and electrically connecting the first pair of individual heating wires to each other in series on one end and connecting the first pair of individual heating wires to a voltage supply on an opposite end; and cutting the inner core tube to the desired final length; whereby a portion of individual heating wires of the first, second, and third electrically conductive layers are series-connected to set the resistance of the system to provide a same total output power based of the input voltage level.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

FIG. 1 is a drawing depicting a longitudinal, cross-sectional view of an exemplary heater hose assembly showing the different layers of the hose assembly.

FIG. 2 is a drawing depicting a perspective view of the heater hose assembly of FIG. 1 showing the different layers of the hose assembly.

FIG. 3 is a drawing depicting another perspective view of the heater hose assembly of FIG. 1 from a different viewpoint as compared to FIG. 2, and showing the different layers of the hose assembly.

FIG. 4 is a drawing depicting a side perspective view of the heater hose assembly of FIG. 1, and illustrating additional details of an exemplary heater wire configuration of the electrically conductive layers.

### DETAILED DESCRIPTION

Embodiments of the present application will now be described with reference to the drawings, wherein like reference numerals are used to refer to like elements throughout. It will be understood that the figures are not necessarily to scale.

The present application discloses an improved heater hose configuration that is readily adaptable to different input voltage levels to be able to maintain a desired power output regardless of the voltage level of the input voltage supply. Such enhancement is achieved by a hose assembly configuration that has multiple electrically conductive layers of heating wires that are separated from each other by electrically non-conductive separating layers. Individual heating wires of the electrically conductive layers are electrically connectable in series to other individual heating wires of the electrically conductive layers, either to individual heating wires within a given electrically conductive layer and/or to individual heating wires of an adjacent electrically conductive layer. The total electrical resistance of the system is determined by the number of series-connected individual heating wires of the electrically conductive layers. Given that user input voltage supplies can differ in voltage level, the output power of the heater hose can be set to a same, desired total output power by series-connecting a selected number of individual heating wires based on the particular input voltage level that is accessible to achieve such desired total output power.

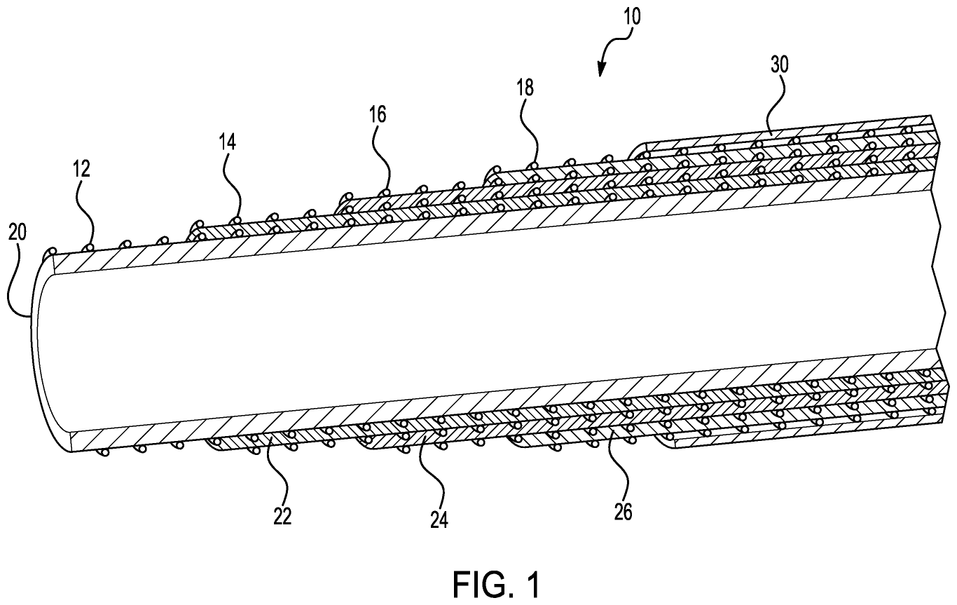

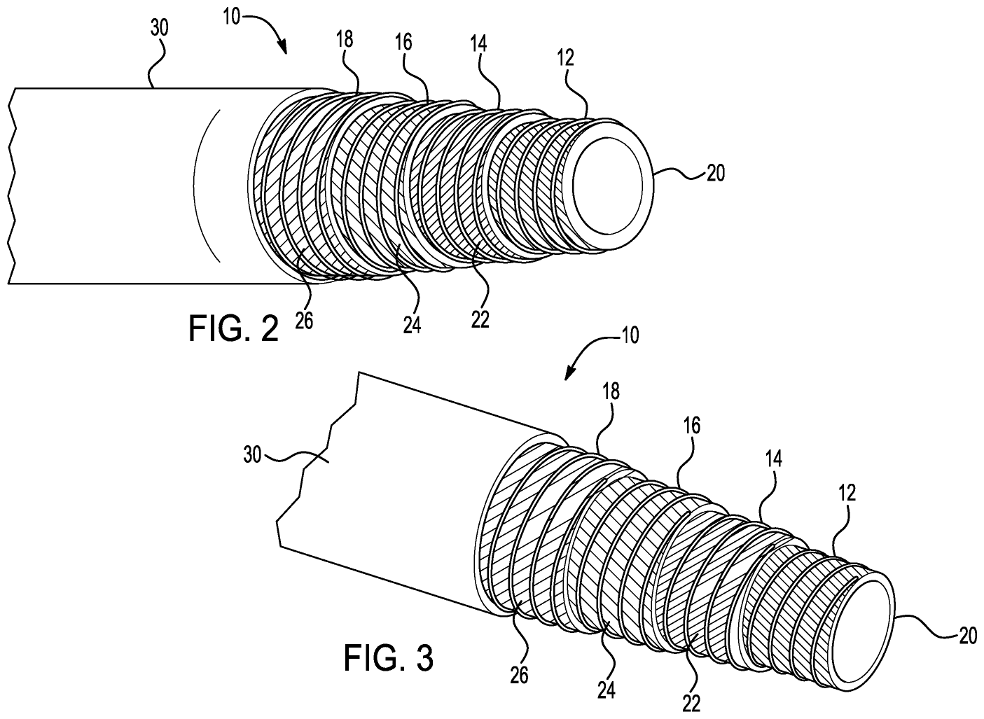

Referring to FIGS. 1-3, a hose assembly 10 includes an electrically non-conductive central or inner core tube 20 for flow of a process fluid through the inner core tube. The inner core tube 20 may be a flexible tube. Similarly as to conventional configurations, in one example the core tube 20 may include a nylon core reinforced with a fiber or aramid braid, which is covered with a polyurethane sleeve. In general, the central core tube 20 is surrounded by alternating electrically conductive layers of electrically conductive heating wire and electrically non-conductive separating layers. The electrically conductive layers of electrically conductive heating wire each may include metal or metal alloy wiring, for example copper wiring, that generates heat due to electrical resistance when an electric current flows through the heating wires. The electrical resistance of the heating wire may be 0.049 Ω/m or lower, or 40.50 Ω/m or higher, or between 0.049-40.50 Ω/m. Those of ordinary skill in the art would understand that the electrical resistance of the heating wire can be varied by changing the material or the number of individual filaments contained within a wire. The electrically non-conductive separating layers each constitutes a thin, electrical insulating material layer that may be made of a polymeric material or polymer composite material, and optionally may also be thermally conductive. For example, the thermal conductivity of the electrically non-conducting separating layer can optionally be 0.40 W/m/K or higher.

In the example depicted in FIGS. 1-3, the flexible central or inner core tube 20 is surrounded by a first electrically conductive layer of heating wire 12, and the first electrically conductive layer of heating wire 12 is surrounded by a first electrically non-conductive separating layer 22. The first electrically non-conductive separating layer 22 is surrounded by a second electrically conductive layer of heating wire 14, and the second electrically conductive layer of heating wire 14 is surrounded by a second electrically non-conductive separating layer 24. The second electrically non-conductive separating layer 24 is surrounded by a third electrically conductive layer of heating wire 16, and the third electrically conductive layer of heating wire 16 is surrounded by a third electrically non-conductive separating layer 26. The third electrically non-conductive separating layer 26 is surrounded by a fourth electrically conductive layer of heating wire 18, and the fourth electrically conductive layer of heating wire 18 is surrounded by a cover layer 30. In this manner, an electrically non-conductive separating layer is positioned between each two adjacent electrically conductive layers of the plurality of electrically conductive layers, whereby an outer combination of electrically non-conductive separating layer and conductive layer surrounds a radially inward electrically conductive layer. The cover layer 30 may be made of a polymeric composition with a foamed cellular structure which forms a thermal insulating layer and provides protection from wear and abrasion. For example, the thermal conductivity cover layer of the thermally insulating layer may be between 0.020-0.200 W/m/K, or lower than 0.020 W/m/K. In a variation on such configuration, a fourth electrically non-conductive separating layer (not shown) can be positioned around the outermost conductive heating wire layer (e.g., the fourth electrically conductive layer 18), and the cover layer 30 may be provided surrounding such fourth electrically non-conductive separating layer. An additional protective outer layer (not shown) also may be positioned over the cover layer 30 depending on the particular application, with such outer layer being formed using a wrapping operation or braiding operation, or by extruding a polymeric composition over the cover layer 30.

Although the example of FIGS. 1-3 includes four electrically conductive layers interspersed with three electrically non-conductive layers, it will be appreciated that any suitable number of conductive layers interspersed with non-conductive layers may be employed. Furthermore, in another example an additional non-conductive separating layer may be provided between the outermost conductive layer and the cover layer.

Example materials for the various components may include the following. The inner core tube, the separating layers, and/or the insulation layers may be made of a rubber material, a thermoplastic material, or a thermosetting material or comparable. Furthermore, any of such layers could include an alloy, blend, or composite of any of such materials.

The rubber material can be chosen from, for example, natural or synthetic rubber such as a fluoropolymer, chlorosulfonate, polybutadiene, butyl rubber, chloroprene, neoprene, nitrile rubber, natural polyisoprene, synthetic polyisoprene, halogenated butyl rubber, hydrogenated butyl rubber, and buna-N, copolymer rubbers such as ethylene-propylene (EPR), ethylene-propylene-diene monomer (EPDM), nitrile-butadiene (NBR), and styrene-butadiene (SBR), polyacrylate rubber, or combinations of two or more thereof. The term “synthetic rubbers” also should be understood to encompass materials that may be classified broadly as thermosetting elastomers such as polyurethanes, silicones, fluorosilicones, styrene-isoprene-styrene (SIS), fluoroelastomers such as FKM, perfluoroelastomers such as FFKM, chlorosulfonated polyethylene, and styrene-butadiene-styrene (SBS), as well as other polymers which exhibit rubber-like properties such as plasticized nylons, polyesters, ethylene vinyl acetates, and polyvinyl chlorides. The thermoplastic material can be chosen from, for example, the family of polymers including, but not limited to, polyolefins, polyamides, polyesters, polyurethanes, polyaramids, fluoropolymers, polysulfones, polysulfides, polyketones, polyethers, polyether ketones, polyanhydrides, polyimides, liquid crystal polymers, thermoplastic vulcanizates (TPV), ionomers, thermoplastic elastomers (TPE). A combination of the above listed polymers involving homopolymers, copolymers, composites, blends or alloys can be used.

The thermoplastic material for the separating and/or insulating layers may be a foamed material, which may have a closed-cell morphology. The closed-cell morphology may provide protection to the covered hose against ingression of environmental fluids. The foamed thermoplastic material may have a semi closed-cell structure, or an open-cell structure. In any of the above examples, the foamed thermoplastic material may include an outer skin or an additional outer layer that covers the cells of the foamed thermoplastic material. The foamed thermoplastic material may have at least 20% density reduction relative to the corresponding density of the thermoplastic material in the un-foamed state. “Reduction in density” or “density reduction” may be understood to mean a percentage reduction in the density of a foamed material, based on the density of the non-foamed starting material measured under the same environmental conditions. The foamed thermoplastic material may have at least 40% density reduction, or more generally from 40% to 99% density reduction relative to the corresponding density of the thermoplastic material in the un-foamed state. The cellular morphology of the foamed thermoplastic material may be classified as macrocellular characterized by an average cell diameter 100 micrometers (μm) or greater. Alternatively, the cellular morphology of the foamed thermoplastic material may be classified as microcellular characterized by an average cell diameter between 1 μm and 100 μm. Alternatively, the cellular morphology of the foamed thermoplastic polymer material may be classified as ultramicrocellular characterized by an average cell diameter anywhere from 0.1 μm to 1 μm. Alternatively, the cellular morphology of the foamed thermoplastic polymer material is classified as nanocellular characterized by an average cell diameter anywhere from 0.001 μm to 0.1 μm.

The rubber or thermoplastic material may include one or more additives. Examples include, but are not limited to, one or more plasticizers, compatibilizers, anti-oxidants, UV stabilizers, radiopaque compounds, colorants (pigments or dyes), flow modifiers, impact modifiers, elastomers (such as in thermoplastic elastomers), cross-linked rubber (such as in thermoplastic vulcanizates), lubricants, releasing agents, coupling agents, cross-linking agents, dispersing agents, foam nucleating agents, flame retardants, reinforcing metals, minerals, nucleating agents, fillers (such as talc, clay, mica, graphite, carbon black, carbon nanotubes, graphene, silica, POSS, powdered metals, powdered ceramics, metal or ceramic based nanowires, glass fibers etc.), and/or a combination of any of the listed additives. The one or more additives may be combined with the thermoplastic material prior to formation of the thermoplastic layer.

The physical separation of conductive layers 12, 14, 16, and 18 of heating wire by the non-conductive separating layers 22, 24, and 26 simplifies the process of making electrical connections through the hose assembly 10, as well as facilitating integration of the hose assembly 10 with other fluid system components. As used in the context of hose materials and components, bonding refers to the joining of components in a manner that separating the components results in destruction of such components. Bonding may be contrasted with simple attachment or physical contact that would permit component separation while maintaining the components intact. In the hose assembly 10, each separating layer is not bonded to any other layer, and the attachment is characterized as physical contact without bonding. More specifically, the non-conductive separating layers 22, 24, and 26, as well as the cover 30, are not bonded to any wiring in any of the heating wire conductive layers 12, 14, 16, and 18, yet the non-conductive separating layers and cover maintain physical contact with heating wires of adjacent heating wire conductive layers and adjacent separating layers. As further detailed below, this configuration, whereby adjacent layers are attached in physical contact but without actually being bonded together, enables ease of skiving and detaching the conductive heating wires from adjacent separating layers and cover layer to expose ends of individual heating wires to facilitate making electrical connections between heating wires on the same or between different conductive layers. The non-conductive separating layers 22, 24, and 26 and cover 30 may be color-coded, whereby the separating layers are each a different color for ease of identification and marking. The multiple conductive layers of conductive heating wires 12, 14, 16, and 18 allows for the application of different input voltage levels to the hose assembly 10, while maintaining a constant power output.

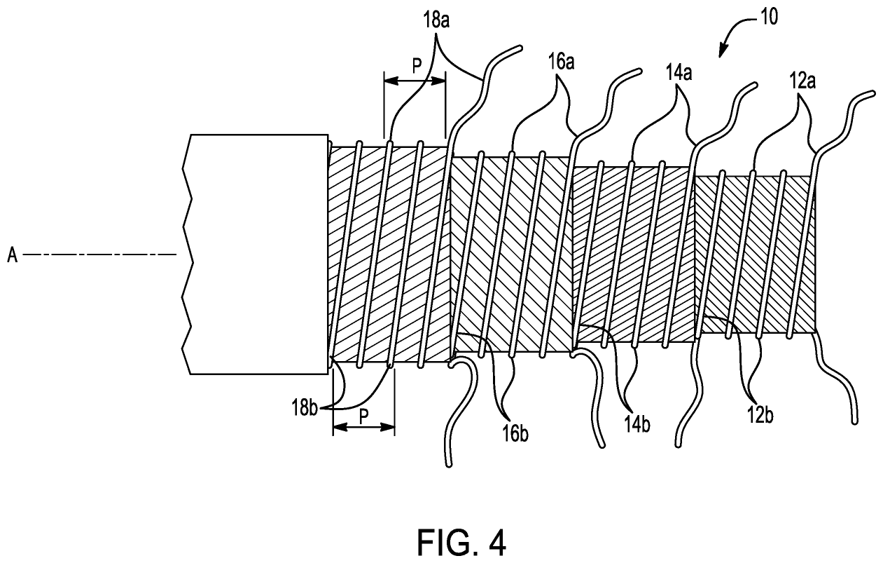

FIG. 4 is a drawing depicting a side perspective view of the heater hose assembly 10 of FIG. 1, and illustrating additional details of an exemplary heating wire configuration of the conductive layers. In the example configuration depicted in FIG. 4, each conductive layer 12, 14, 16, and 18 includes at least one pair of individual conductive heating wires (12a/12b, 14a/14b, 16a/16b, and 18a/18b) such that each individual conductive heating wire can be electrically connected in a series circuit to another individual conductive heating wire, either within the same conductive layer or in a different (typically adjacent) conductive layer. Each of the individual heating wires is helically wound such that within a given conductive layer, windings of a heating wire pair alternate. In other words, as seen in FIG. 4 windings of individual heating wire 12a alternate with windings of individual heating wire 12b, windings of individual heating wire 14a alternate with windings of individual heating wire 14b, and so on. A wire pitch “P” is defined as a longitudinal distance along a longitudinal axis “A” between two windings of a given individual heating wire, with a pitch angle being an angle of the windings relative to the longitudinal axis. In FIG. 4, the wire pitch P is illustrated as to individual heating wires 18a and 18b, and it will be appreciated that the other individual heating wires have a pitch that is defined in like manner. The wire pitches and/or pitch angles of the various individual heating wires of the conductive layers may be equal or different relative to each other.

The conductive layers of heating wire 12, 14, 16, and 18 are arranged such that the innermost conductive layer 12 is positioned to receive an input voltage of a given voltage level, and one or more of the relatively outer conductive layers 14, 16, and 18 may be electrically connected in series with the innermost conductive layer 12, with the connection of additional conductive layers from innermost to outermost being positioned to progressively accommodate a higher input voltage level at the innermost conductive layer 12. In particular, as each successive conductive heating wire is electrically connected in series, whether being another heating wire of a heating wire pair within a particular conductive layer or the connection of a heating wire in the next outermost conductive layer, the overall length of the series-connected individual heating wires increases thereby increasing the total electrical resistance of the system. In other words, to increase the total electrical resistance of the system, individual heating wire 12a may be electrically connected to individual heating wire 12b; individual heating wire 12b further may be electrically connected to individual heating wire 14a; individual heating wire 14a may be electrically connected to individual heating wire 14b; individual heating wire 14b further may be electrically connected to individual heating wire 16a; and so on, with each successive series connection increasing the length, and therefore the electrical resistance, of the system. As further detailed below as to implementation of the hose assembly 10 for particular applications, FIG. 4 illustrates that with the cover and the non-conductive separating layers skived back, ends of the individual heating wires can be exposed for connection to other individual heating wires.

Accordingly, the number of conductive heating wires in the series electrical connection can be implemented in relation to the voltage level of the input voltage supply that is available for a particular user to achieve the same power output. With increasing voltage level of the input voltage supply, higher electrical resistance is needed to achieve the same power output and thus a larger number of conductive heating wires are electrically connected. Because the innermost conductive layer 12 is closest to the inner core tube 20, heat is more readily provided to the inner core tube by such innermost conductive layer, followed by the next closest conductive layer 14, and so on. Accordingly, the individual heating wires are added to the series connection to accommodate higher voltage level inputs from the innermost conductive layer 12 progressively toward the outermost conductive layer 18. Once an appropriate number of individual heating wires are series-connected to achieve the constant desired power output, any additional individual heating wires in the system remain electrically disconnected.

As described above, one manner of achieving a requisite total resistance is by setting the overall length of the series-connected individual heating wires based on the number of connected heating wires through the hose assembly. Related parameters that affect the total resistance include physical properties of the heating wires and the configuration by which the heating wires are wound to form the conductive layer. As referenced above, each conductive layer may contain at least one pair of individual conductive heating wires (12a/12b, 14a/14b, 16a/16b, 18a/18b). The individual heating wires are helically wound heating wires that have a specific resistance per unit length and are helically wound at a predetermined pitch and angle, which set the overall length of each of the individual heating wires. Because the diameter of each conductive layer about the central core tube increases from innermost to outermost as the overall diameter of the hose assembly increases, with physical parameters being the same for each conductive heating layer each subsequent conductive layer from innermost to outermost has a total electrical resistance that is higher that the preceding inner conductive layer. The result is that for any length of hose assembly 10, the same power output is always achieved while the voltage level is increased for each subsequent conductive layer used when the individual heating wires are series connected.

The tables below set forth non-limiting examples of configurations for the hose assembly 10. Referring to the first table for Hose Design Example 1, the table shows the configuration parameters of a hose assembly design having three conductive layers, the electrical resistance of the conductive layers increasing with each subsequent layer electrically connected in series from innermost to outermost layer to maintain a constant output power with differing input voltage levels. As used herein, the combined electrical resistance is the total electrical resistance of a conductive layer (i.e., the electrical resistance in Ohms/m times the length of hose in meters (m) times the number of connected heating wires in the conductive layer). The pitch and angle of the helical windings for the heating wires in each conductive layer also are set forth. The example input operating voltages of 12V, 24V, and 48V are typical input voltage levels for common heater hose applications. The second table for Hose Design Example 2 shows an example associated with configuration patterns for a hose assembly design having two conductive layers.

### Hose Design Example 1

| Hose Design 1 | Symbol | Value | Unit |
|---|---|---|---|
| Inner Conduit/Core Tube | — | | |
| Inner Diameter | D₀ | 0.0175 | m |
| Thickness | | 0.0010 | m |
| Length | L | 0.7000 | m |
| 1st Electrical Layer | — | | |
| Specific Resistance | R₁ | 1.12 | Ω/m |
| of each wire in 1st | | | |
| electrical layer | | | |
| Length of each wire | L₁ | 1.2804 | m |
| required in 1st | | | |
| electrical layer | | | |
| Angle | A₁ | 0.99 | radians |
| Pitch of each wire | P₁ | 0.0400 | m |
| from one pair | | | |
| 1st Separating Layer | — | | |
| Thickness | | 0.0002 | m |
| Thermal Conductivity | | 0.400 | W/m/K |
| 2nd Electrical Layer | | | |
| Specific Resistance | R₂ | 4.00 | Ω/m |
| of each Wire in 2nd | | | |
| electrical layer | | | |
| Length of each wire | L₂ | 1.0800 | m |
| required in 2nd | | | |
| electrical layer | | | |
| Angle | A₂ | 0.87 | radians |
| Pitch of each wire | P₂ | 0.0532 | m |
| from one pair | | | |
| 2nd Separating Layer | — | | |
| Thickness | | 0.0002 | m |
| Thermal Conductivity | | 0.400 | W/m/K |
| 3rd Electrical Layer | | | |
| Specific Resistance | R₃ | 19.00 | Ω/m |
| of each Wire in 3rd | | | |
| electrical layer | | | |
| Length of each wire | L₃ | 0.9100 | m |
| required in 3rd | | | |
| electrical layer | | | |
| Angle | A₃ | 0.69 | radians |
| Pitch of each wire | P₃ | 0.0769 | m |
| from one pair | | | |
| 3rd Separating Layer | — | | |
| Thickness | | 0.0002 | m |
| Thermal Conductivity | | 0.200 | W/m/K |
| Outer Insulating Layer | — | | |
| Thickness | | 0.0020 | m |
| Thermal Conductivity | | 0.040 | W/m/K |

Operating Parameters

| Voltage | V₁ = 12 V | V₂ = 24 V | V₃ = 48 V |
|---|---|---|---|
| Electrical Layer 1 | Yes | Yes | Yes |
| Electrical Layer 2 | — | Yes | Yes |
| Electrical Layer 3 | — | — | Yes |
| Power | 50 W | 50 W | 50 W |

### Hose Design Example 2

| Hose Design 2 | Symbol | Value | Unit |
|---|---|---|---|
| Inner Conduit/Core Tube | — | | |
| Inner Diameter | D₀ | 0.0254 | m |
| Thickness | | 0.0010 | m |
| Length | L | 1.0000 | m |
| 1st Electrical Layer | — | | |
| Specific Resistance | R₁ | 1.45 | Ω/m |
| of each wire in 1st | | | |
| electrical layer | | | |
| Length of each wire | L₁ | 1.9909 | m |
| required in 1st | | | |
| electrical layer | | | |
| Angle | A₁ | 1.04 | radians |
| Pitch of each wire | P₁ | 0.0500 | m |
| from one pair | | | |
| 1st Separating Layer | — | | |
| Thickness | | 0.0005 | m |
| Thermal Conductivity | | 2.0000 | W/m/K |
| 2nd Electrical Layer | | | |
| Specific Resistance | R₂ | 6.00 | Ω/m |
| of each Wire in 2nd | | | |
| electrical layer | | | |
| Length of each wire | L₂ | 1.4400 | m |
| required in 2nd | | | |
| electrical layer | | | |
| Angle | A₂ | 0.80 | radians |
| Pitch of each wire | P₂ | 0.0861 | m |
| from one pair | | | |
| 2nd Separating Layer | — | | |
| Thickness | | 0.0005 | m |
| Thermal Conductivity | | 2.0000 | W/m/K |
| Outer Insulating Layer | — | | |
| Thickness | | 0.0025 | m |
| Thermal Conductivity | | 0.025 | W/m/K |

Operating Parameters

| Voltage | V₁ = 24 V | V₂ = 48 V |
|---|---|---|
| Electrical Layer 1 | Yes | Yes |
| Electrical Layer 2 | — | Yes |
| Power | 100 W | 100 W |

In another example of a multi-voltage, electrical heater hose for heating a fluid medium by providing a fixed total power output (P) (Hose Design Example 3), the heater hose includes an inner core tube of length L in direct contact with the fluid medium, and a single conductive layer having a first pair and a second pair of helically wound heating wires. The first pair of helically wound heating wires have a combined electrical resistance R₁ and are wound at a pitch P₁ and winding angle A₁ so as to provide a total desirable length L₁ of each wire of the first pair of helically wound heating wires along the length L of the inner core tube, such that a total power output P is obtained upon application of a chosen voltage V₁ through the first pair of helically wound heating wires. The second pair of helically wound heating wires have a combined resistance R₂ and are helically wound at a pitch P₂ and winding angle A₂ so as to provide a total desirable length L₂ of each wire of the second pair of helically wound heating wires along the length L of the inner core tube, such that a same total power output (P) is obtained by connecting in series the first pair of helically wound heating wires and second pair of helically wound heating wires and upon application of a chosen voltage V₂ through the helically wound heating wires of the first and second pairs of helically wound heating wires. The heater hose further includes an outer thermal insulating layer that prevents heat loss from the heater hose to outer surroundings and protects the conductive layer. The heater hose further may include a non-conductive separating layer disposed between the single conductive layer and the outer thermal insulating layer, the non-conductive separating layer including an electrically insulating polymer composition. The pitches and winding angles of the first and second pairs of helically wound heating wires may be equal.

### Hose Design Example 3

| Hose Design 3 | Symbol | Value | Unit |
|---|---|---|---|
| Inner Conduit/Core Tube | — | | |
| Inner Diameter | D₀ | 0.0254 | m |
| Thickness | | 0.0010 | m |
| Length | L | 1.0000 | m |
| 1st pair of heating wire | — | | |
| Specific Resistance of | R₁ | 1.45 | Ω/m |
| each wire from 1st pair | | | |
| Length of each wire | L₁ | 1.9909 | m |
| from 1st pair | | | |
| Angle | A₁ | 1.04 | radians |
| Pitch of each wire | P₁ | 0.0500 | m |
| from 1st pair | | | |
| 2nd pair of heating wire | | | |
| Specific Resistance of | R₂ | 4.34 | Ω/m |
| each Wire from 2nd pair | | | |
| Length of each wire | L₂ | 1.9909 | m |
| required from 2nd pair | | | |
| Angle | A₂ | 1.04 | radians |
| Pitch of each wire | P₂ | 0.0500 | m |
| from 2nd pair | | | |
| Outer Insulating Layer | — | | |
| Thickness | | 0.0020 | m |
| Thermal Conductivity | | 0.040 | W/m/K |

Operating Parameters

| Voltage | V₁ = 24 V | V₂ = 48 V |
|---|---|---|
| First Pair | Yes | Yes |
| Second Pair | — | Yes |
| Power | 100 W | 100 W |

An exemplary manufacturing and implementation process may be performed as follows. In general, a method of implementing a hose assembly includes the steps of: extruding a thermoplastic polymer composition to form an inner core tube; helically wrapping a first conductive layer on the inner core tube; extruding a polymeric composition on the first conductive layer to form a first separating layer; helically wrapping a second conductive layer on the first separating layer; extruding a polymeric composition on the second conductive layer to form a second separating layer; helically wrapping a third conductive layer on the second separating layer; and extruding a polymeric composition with a foamed cellular structure to form a thermal insulating cover layer. The method further may include the steps of: cutting the hose assembly to a length greater than a desired final length; skiving and removing from both ends of the hose assembly the outer insulating cover layer and underlying electrical and separating layers to the desired final length, thereby exposing first, second, and third pairs of individual heating wires respectively of the first, second, and third conductive layers; unravelling the first pair of individual heating wires of the first conductive layer from both ends and electrically connecting the first pair of individual heating wires to each other in series on one end and connecting the first pair of individual heating wires to a voltage supply on an opposite end; and cutting the inner core tube to the desired final length. A selected number of individual heating wires may be connected in series such that a total output power of the hose assembly based on a voltage level of the input voltage supply is a same desired total output power.

Referring to the figures, the hose assembly 10 may be formed in a continuous manufacturing of tubular assemblies, including the inner core tube 20, the heating wires that form the conductive layers 12, 14, 16, and 18, the non-conductive separating layers 22, 24, and 36, and the cover 30, to form a stock length of the hose assembly 10. Any suitable manufacturing process, such as molding, extruding, and other types of forming operations may be employed to form the stock length of the hose assembly. The configuration of the hose assembly, therefore, has flexibility in the manufacturing processes that may be used. The stock length can then be cut or otherwise formed to provide shorter sections of the hose assembly that have a length more suitable for storage, shipping, and the like. The hose assembly may be cut into a desired length, and the cut length further may be thermal formed into a desired shape using a pre-defined mold geometry.

The electrical connections of the heating wires within and between conductive layers are easily made by first cutting the hose assembly into a length greater than the desirable final length for use in a particular application to enable the formation of electrical connections through the hose assembly. Next, a skiving or comparable process is used to remove portions of the cover layer and separating layers from both ends to achieve the desirable final length for a particular application. This exposes the underlying conductive heater wiring and non-conductive separating layers, which permits unravelling each pair of heating wires in each conductive layer from both ends. Depending upon the voltage level of the input voltage supply, a suitable number of the unraveled individual heating wires are connected to each other in series on both ends, and the resulting series-connection of heating wires in turn is connected via the innermost conductive layer to the input voltage supply at either end. Any excess individual heating wires that are not needed in relation to the input voltage supply level remain electrically disconnected. The inner core tube is then cut to the desirable final length for the particular application.

In this manner, the configuration of the hose assembly of the present application allows for more efficient operation and tighter control of the product dimensions, uniformity, and performance across various applications. A further benefit of the hose assembly is that the integrated non-conductive separating layers constitute a flexible polymeric material such that the hose assembly can easily conform to the bends and twists of the inner core tube as required for positioning in any particular application. The integrated insulation of the cover layer also provides additional benefit with regards to noise, vibration and harshness (NVH) dampening due to the continuous physical contact with the underlying outermost conductive layer 18 and non-conductive separating layer 26. The ability to configure the series electrical connections of the heating wires to achieve the same power output for different input voltage levels means that a single hose assembly is versatile for a variety of different heater hose applications.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above-described elements (components, assemblies, devices, compositions, etc.), the terms (including a reference to a “means”) used to described such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A hose assembly comprising:
an electrically non-conductive core tube;
a plurality of electrically conductive layers of heating wire, wherein a first electrically conductive layer of the plurality of electrically conductive layers surrounds the electrically non-conductive core tube;
an electrically non-conductive separating layer between each two adjacent electrically conductive layers of the plurality of electrically conductive layers, whereby an outer combination of electrically non-conductive separating layer and electrically conductive layer surrounds a radially inward electrically conductive layer; and
an electrically non-conductive insulating cover layer surrounding an outermost electrically conductive layer of the plurality of electrically conductive layers;
wherein at least a portion of the electrically non-conductive separating layer between each two adjacent electrically conductive layers of the plurality of electrically conductive layers is configured to be removable to reveal at least a portion of the radially inward electrically conductive layer;
wherein each electrically conductive layer of the plurality of electrically conductive layers includes a pair of helically wound individual heating wires; and
wherein the pair of helically wound individual heating wires are configured to be connectable after the removal of the at least a portion of the electrically non-conductive separating layer.

2. The hose assembly of claim 1, wherein a first pair of helically wound individual heating wires of a first electrically conductive layer of the plurality of electrically conductive layers has a first combined resistance, wherein a total power output is produced upon application of a first voltage through the individual heating wires of the first electrically conductive layer.

3. The hose assembly of claim 2, wherein a second pair of helically wound individual heating wires of a second electrically conductive layer of the plurality of electrically conductive layers has a second combined resistance, wherein when the first and second electrically conductive layers are electrically connected in series, application of a second voltage through the individual heating wires of the first and second electrically conductive layers produces the total power output that is produced upon application of the first voltage through the individual heating wires of the first electrically conductive layer.

4. The hose assembly of claim 3, wherein a third pair of helically wound individual heating wires of a third electrically conductive layer of the plurality of electrically conductive layers has a third combined resistance, wherein when the third electrically conductive layer is electrically connected in series to the first and second electrically conductive layers, application of a third voltage through the individual heating wires of the first, second, and third electrically conductive layers produces the total power output that is produced upon application of the first voltage through the individual heating wires of the first electrically conductive layer.

5. The hose assembly of claim 1, wherein the individual heating wires are helically wound at a pitch and a pitch angle relative to a longitudinal axis of the hose assembly.

6. The hose assembly of claim 5, wherein the pitch and/or the pitch angle of individual heating wires of different electrically conductive layers are equal.

7. The hose assembly of claim 1, wherein within a given pair of helically wound individual heating wires, windings of a first individual heating wire alternate with windings of a second individual heating wire.

8. The hose assembly of claim 1, wherein each separating layer is not bonded to any other layer; and
wherein each separating layer is made of a thermally conducting polymer composite material that is also an electrical insulating material.

9. (canceled)

10. The hose assembly of claim 1, wherein the separating layers are each a different color; and
wherein the pair of helically wound individual heating wires of the plurality of electrically conductive layers are each a different color.

11. (canceled)

12. A method of implementing a hose assembly comprising the steps of:
extruding a thermoplastic polymer composition to form an inner core tube;
helically wrapping a first electrically conductive layer on the inner core tube;
extruding a polymeric composition on the first electrically conductive layer to form a first separating layer;
helically wrapping a second electrically conductive layer on the first separating layer;
extruding a polymeric composition on the second electrically conductive layer to form a second separating layer;
helically wrapping a third electrically conductive layer on the second separating layer;
extruding a polymeric composition with a foamed cellular structure to form an outer thermal insulating cover layer;
cutting the hose assembly to a length greater than a desired final length,
skiving and removing from both ends of the hose assembly the outer thermal insulating cover layer and an underlying one of the separating layers to the desired final length, thereby exposing first, second, and third pairs of individual heating wires respectively of the first, second, and third electrically conductive layers, and
unravelling the first pair of individual heating wires of the first electrically conductive layer from both ends and electrically connecting the individual heating wires of first pair to each other in series on one end and to a voltage supply on an opposite end.

13. The method of claim 12, further comprising the step of extruding a polymeric composition on the third electrically conductive layer to form a third separating layer prior to forming the thermal insulating cover layer.

14. The method of claim 12, further comprising the step of:
providing a protective outer layer on the thermal insulating cover layer by a wrapping operation or braiding operation, or by extruding a polymeric composition.

15. The method of claim 12, further comprising the step of:
cutting the hose assembly into a desired length and thermal forming the cut length into a desired shape using a pre-defined mold geometry.

16. The method of claim 12, further comprising the step of:
cutting the inner core tube to the desired final length.

17. The method of claim 16, further comprising the steps of unravelling the second pair of individual heating wires of the second electrically conductive layer and electrically connecting the second pair of individual heating wires to each other and to the first pair of individual heating wires in series.

18. The method of claim 17, further comprising the step of unravelling the third pair of individual heating wires of the third electrically conductive layer and electrically connecting the third pair of individual heating wires to each other and to the second pair of individual heating wires in series.

19. The method of claim 17, further comprising the step of connecting a selected number of individual heating wires in series such that a total output power of the hose assembly based on a voltage level of the voltage supply is a desired total output power.

20. A multi-voltage, electrical heater hose for heating a fluid medium by providing a fixed total power output (P), the heater hose comprising:
an inner core tube of length L in direct contact with the fluid medium;
a single electrically conductive layer comprising a first pair and a second pair of helically wound heating wires;
wherein the first pair of helically wound heating wires have a combined electrical resistance R₁ and are wound at a pitch P₁ and winding angle A₁ so as to provide a total desirable length L₁ of each wire of the first pair of helically wound heating wires along the length L of the inner core tube, such that a total power output P is obtained upon application of a chosen voltage V₁ through the first pair of helically wound heating wires;
wherein the second pair of helically wound heating wires have a combined resistance R₂ and are helically wound at a pitch P₂ and winding angle A₂ so as to provide a total desirable length L₂ of each wire of the second pair of helically wound heating wires along the length L of the inner core tube, such that a same total power output (P) is obtained by connecting in series the first pair of helically wound heating wires and second pair of helically wound heating wires and upon application of a chosen voltage V₂ through the helically wound heating wires of the first and second pairs of helically wound heating wires; and
an outer thermal insulating layer that prevents heat loss from the heater hose to outer surroundings and protects the electrically conductive layer.

21. The heater hose of claim 20, further comprising an electrically non-conductive separating layer disposed between the single electrically conductive layer and the outer thermal insulating layer, the electrically non-conductive separating layer comprising an electrically insulating polymer composition.

22. The heater hose of claim 20, wherein the pitches and winding angles of the first and second pairs of helically wound heating wires are equal.

23. (canceled)
